(19) United States
(12) Patent Application Publication
(10) Pub. No.: US 2026/0102717 A1
(43) Pub. Date: Apr. 16, 2026

(54) FLUID SEPARATION SYSTEM AND METHOD

(71) Applicant: LignoSol IP Limited, San Gwann (MT)

(72) Inventors: Desmond Alexander SOMERVILLE, San Gwann (MT); Patrick Dieter WAIBEL, San Gwann (MT)

(21) Appl. No.: 19/115,484

(22) PCT Filed: Sep. 26, 2023
(86) PCT No.: PCT/IB2023/059500

§ 371 Date: Mar. 26, 2025

(30) Foreign Application Priority Data
Sep. 27, 2022 (GB) 2214123.8

(51) Int. Cl. B01D 17/04; E21B 43/34

(52) U.S. Cl. CPC B01D 17/047; E21B 43/34

(57) ABSTRACT

A system is provided for treating fluids, in particular a fluid comprising a mixture of oil and water. The fluid is conditioned in a treatment apparatus for accelerated and/or enhanced separation of the oil and water fractions in a conventional oil and water separation tank.

### BACKGROUND OF THE INVENTION

This invention relates to a system for treating a fluid, in particular a fluid comprising oil and water to be separated into its constituent fractions.

A large number of different tank arrangements and techniques exist for the separation and recovery of oil from various oil-containing fluids.

For instance, different oil and water separation tanks of various designs and utilizing different treatment compositions are employed to cause separation of oil and water fractions from fluids comprising them. Skimmers, weirs, and the like are then used to take off the oil fraction and the water fraction is typically tapped off for further treatment or re-use.

### SUMMARY OF THE INVENTION

In one aspect of the invention, there is provided a system for treating a fluid comprising oil and water, the system comprising:
an oil and water separation tank arranged to separate a fluid comprising oil and water into at least an oil fraction and a water fraction, the water separation tank having an inlet for receiving conditioned fluid comprising oil and water, and respective outlets for recovering, respectively, at least the separated oil and water fractions;
a treatment apparatus comprising an inlet and an outlet and defining a treatment chamber between the inlet and the outlet, the treatment apparatus inlet being in fluid communication with a source of the fluid comprising the oil and water to be conditioned and the treatment chamber including means for disturbing the flow profile of fluid received from the source thereof or agitating the fluid flowing through the chamber, thereby to condition the fluid for enhanced separation; and
a pump arranged in fluid communication with the treatment apparatus and the separation tank to cause the fluid to be conditioned to flow through the treatment apparatus and to the separation tank for the oil and water fractions to be separated and recovered.

In some embodiments, a separate holding tank is provided for receiving the fluid to be conditioned, the holding tank providing the source of the fluid that passes through the treatment apparatus prior to flowing into the separation tank for separation of the at least water and oil fractions.

In some embodiments, the fluid to be separated also comprises sediment, the separation tank being arranged to separate out the sediment, typically by settling out under gravity, and including recovery means for recovering the settled sediment.

In some embodiments, the fluid is pre-mixed with a composition comprising lignin, preferably prior to the fluid being introduced into the treatment apparatus.

In some embodiments, the lignin-based treatment composition is contained in a dosing apparatus that is arranged to dose the fluid to be conditioned prior to it flowing through the treatment apparatus.

In some preferred embodiments the lignin-based treatment composition further comprises at least one isolated strain of bacteria capable of producing at least one biosurfactant, prior to being pumped through the treatment apparatus.

In some embodiments, the separation tank and treatment apparatus are in a closed loop, the treatment apparatus being arranged to receive continuously both unconditioned and conditioned fluid.

Exemplary of such an arrangement is a system for treating a fluid comprising oil and water that comprises:
an oil and water separation tank arranged to separate a fluid comprising oil and water into an oil fraction and a water fraction, the tank having a first inlet for receiving an untreated fluid comprising oil and water, a first outlet for untreated or partially conditioned fluid, a second inlet for receiving conditioned fluid, and second and third outlets for recovering, respectively, the separated oil and water fractions;
a treatment apparatus comprising an inlet and an outlet and defining a treatment chamber between the inlet and the outlet, the inlet being in fluid communication with the first outlet of the separation tank for receiving the untreated or partially conditioned fluid, the treatment chamber including means for disturbing the flow profile of fluid received from the separation tank or agitating the fluid flowing through the chamber, thereby to condition the fluid for enhanced separation; and
a pump arranged between and in fluid communication with the outlet of the treatment apparatus and the second inlet of the separation tank to cause the fluid to be conditioned through the treatment apparatus and return the conditioned fluid to the separation tank.

In some embodiments the treatment apparatus and separation tank, or multiples thereof, are provided in a so-called open arrangement or series of treatment zones between the source of the fluid to be treated and the recovery of the various fractions.

Exemplary of such an arrangement is a system for treating a fluid comprising oil and water that comprises:
a holding tank for receiving fluid comprising oil and water to be treated, for example produced water from an oil well;
an oil and water separation tank arranged to separate the fluid comprising oil and water into at least an oil fraction and a water fraction, the tank having an inlet for receiving conditioned fluid comprising oil and water, and respective outlets for recovering, respectively, at least the separated oil and water fractions;
a treatment apparatus comprising an inlet and an outlet and defining a treatment chamber between the inlet and the outlet, the inlet being in fluid communication with the holding tank for receiving the untreated fluid, the treatment chamber including means for disturbing the flow profile of fluid received from the holding tank or agitating the fluid flowing through the chamber, thereby to condition the fluid for enhanced separation; and
a pump arranged between and in fluid communication with the outlet of the treatment apparatus and the inlet of the separation tank to cause the fluid to be conditioned to flow through the treatment apparatus to the separation tank for separation and recovery of at least the separated oil and water.

Other aspects and features of the present invention will become apparent to those ordinarily skilled in the art upon review of the following description of specific embodiments of the disclosure.

### BRIEF DESCRIPTION OF THE DRAWINGS

The invention will now be described in more detail, by way of example only, with reference to the accompanying drawings in which:

FIG. 1 is a schematic plan view of an exemplary system for separating oil and water fractions from a fluid comprising oil and water, according to some embodiments;

FIG. 2 is a cross-sectional side view of an embodiment of a treatment apparatus of the separation system depicted in FIG. 1;

FIG. 3 is a side view of a further embodiment of a treatment apparatus of the treatment system of the invention, including an illustration of the internal features thereof;

FIG. 4 is a perspective view of the treatment apparatus shown in FIG. 3, further illustrating the internal features of the treatment apparatus;

FIG. 5 is a schematic plan view of an exemplary embodiment of a system for separating oil and water fractions from produced water recovered from an oil well; and

FIG. 6 is a schematic plan view of an exemplary embodiment of another system for separating oil and water fractions from produced water recovered from an oil well

### DESCRIPTION OF PREFERRED EMBODIMENTS

The system of the invention is designed for separating oil and water fractions from fluids comprising a mixture of oil and water.

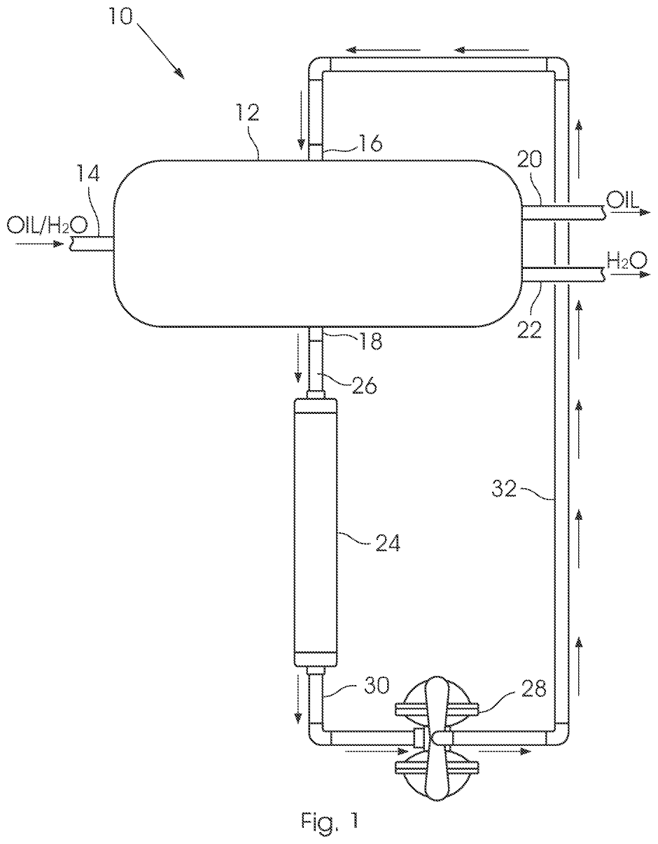

Referring to FIG. 1 of the accompanying drawings, in one embodiment, the treatment system 10 comprises an oil and water separation tank 12, for receiving a fluid comprising a mixture of oil and water via a first inlet 14. The tank 12 includes a second inlet 16 for receiving treated or conditioned fluid, as well as a first outlet 18 for untreated or partially treated or conditioned fluid to be introduced into the rest of the system 10, and second and third outlets 20, 22 for recovering, respectively oil and water fractions separated in tank 12. A treatment apparatus 24 in fluid communication with the first tank outlet 18 is arranged to receive the untreated or partially treated or conditioned fluid from tank 12 via flow pipe 26. Finally, a pump 28 in fluid communication with the treatment apparatus 24 via pipe 30 is provided to suck the fluid through the treatment apparatus 24 and to return the treated or conditioned fluid to the separation tank via outflow pipe 32.

Depending on the design of the oil and water separation tank 12, some of the conditioned fluid from the treatment apparatus 24 may mix with untreated fluid being introduced into the tank 12, hence resulting in a partially treated or conditioned fluid subsequently being introduced into treatment apparatus 24.

By continuously passing untreated or partially treated or conditioned fluid through the treatment apparatus 24, it has been found that the separation of the oil and water fractions is not only accelerated but also enhanced in the separation tank 12, allowing for improved recovery of the oil and water fraction via respective outlets 20, 22. In some embodiments mixing the fluid with a lignin-based composition and then passing it through the treatment system 10 may further enhance the separation process.

It is to be understood that the system 10 depicted in FIG. 1 is for illustrative purposes only, and many variations and adaptions would be evident to a person skilled in the art, in particular for scaling the system up for industrial applications. For example, instead of having a closed tank 12, as depicted in FIG. 1, with an outlet 20 for oil recovery, the tank 12 could be open at the top, with a spillover or rim over which the separated oil can flow into a collection tank or the like, and recovered from there.

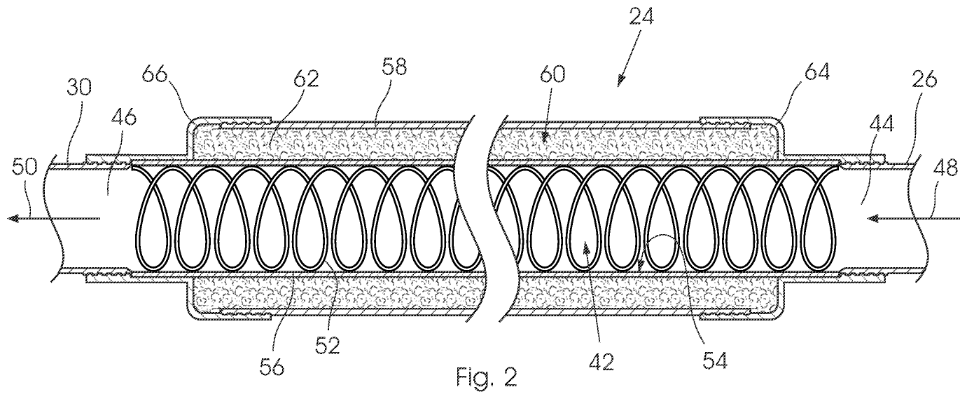

Referring to FIG. 2, an embodiment of the treatment apparatus 24 comprises a treatment chamber 42 with an inlet 44 into the chamber 42 and an outlet 46 from the chamber 42. The inlet 44 is in fluid communication with the first tank outlet 18 via the flow pipe 26 such that the fluid flows through the chamber 42 in the direction shown by the respective arrows 48, 50. One of the key features of the treatment apparatus 24 is that it is designed to disturb or change the flow profile of the fluid or otherwise agitate it as it flows through the treatment chamber 42. For instance, the treatment apparatus 24 in some embodiments is a static mixer, in particular a tubular mixer in which the treatment chamber 42 is circular in cross-section. In the illustrated embodiment the static mixer 24 includes a helical or spiral element 52 positioned along the length of the chamber 42. In other embodiments, this could be a helical or spiral groove (not shown) cut along the length of the inner wall 54 defining the treatment chamber 42. Whichever arrangement is used, the spiral element 52 or groove (not shown) creates vortices in the flowing fluid in order to alter the flow profile thereof and/or agitate it to aid in accelerating the separation of the oil fraction from the water fraction in the tank 12.

In some embodiments of the invention, the helical or spiral element 52 is formed of copper tubing.

In some embodiments, the helical or spiral groove is machined or ‘rifled’ into the inner wall 54.

In this embodiment of the invention, the static mixer 24 comprises a pair of tubular pipes, an inner pipe 56 housing the treatment chamber 42 co-axially located within an outer pipe 58 and defining an annular space 60 between the pipes 56, 58. A particulate mixture 62 of metallic powder or shavings, for example aluminium powder, and crystalline material, such as quartz crystals, for example silica sand, embedded in a resin is sandwiched in the annular space 60 between the pipes 56, 58.

In this embodiment, the inner and outer pipes 56, 58 are coupled to one another and the respective flow pipes 26 and 30 by respective couplings 64 and 66.

Without wishing to be bound by theory, it is believed that the action of disturbing the flow of the hydrocarbon-containing mixture in the presence of the mixture 62 in the treatment apparatus 24 ‘conditions’ the flowing fluid, accelerating and enhancing the separation of the oil and water fractions in tank 12.

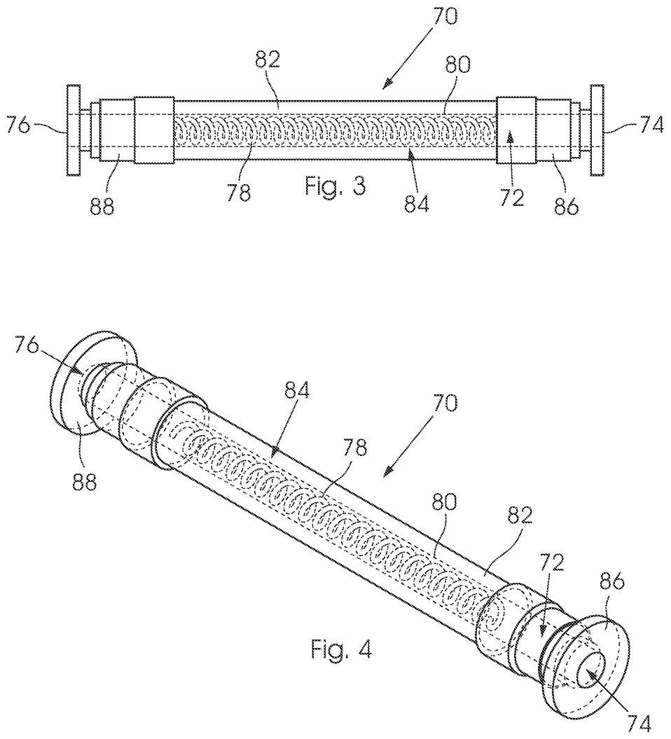

Referring to FIGS. 3 and 4, there is shown a preferred embodiment 70 of the treatment apparatus shown in FIG. 1. The treatment apparatus 70 comprises a treatment chamber 72 with an inlet 74 into the chamber 72 and an outlet 76 from the chamber 72. The inlet 74 is arranged for fluid communication with the tank outlet 18 (not shown). The treatment apparatus 70 in this embodiment is a tubular mixer in which the treatment chamber 72 is circular in cross-section and includes a helical or spiral element 78 positioned along the length of the chamber 72. The helical or spiral element 78 creates vortices in the flowing fluid in order to alter the flow profile thereof and/or agitate it to aid in accelerating the separation of oil and water fractions in the tank 12.

In this embodiment of the invention, the helical or spiral element 78 is formed of copper tubing.

The static mixer 70 comprises a pair of tubular pipes, an inner pipe 80 housing the treatment chamber 72 co-axially located within an outer pipe 82 and defining an annular space 84 between the pipes 80, 82. A particulate mixture of metallic powder or shavings, for example aluminium powder, and crystalline material, such as quartz crystals, for example silica sand, embedded in a resin (not shown) can be sandwiched in the annular space 84 between the pipes 80, 82.

In this embodiment, the inner and outer pipes 80, 82 are coupled to one another by respective couplings 86 and 88.

In some embodiments, the fluid comprises a multiphase fluid. As used herein, “multiphase fluid” refers to a fluid comprising at least one additional phase, being a solid and/or gas phase. In other embodiments, the fluid may comprise a liquid that is relatively free of solid material and/or gas.

In some embodiments, the fluid may comprise an emulsion. For example, the fluid may comprise an oil-water emulsion such as an oil-in-water emulsion or a water-in-oil emulsion. In some embodiments, the emulsion may further comprise at least a portion of particulate matter. As one example, water-in-oil emulsions may be produced during crude oil recovery due to naturally occurring water in the reservoir. Such oil-in-water or water-in-oil emulsions may also comprise at least a portion of entrained sand, clay, or other such sediment.

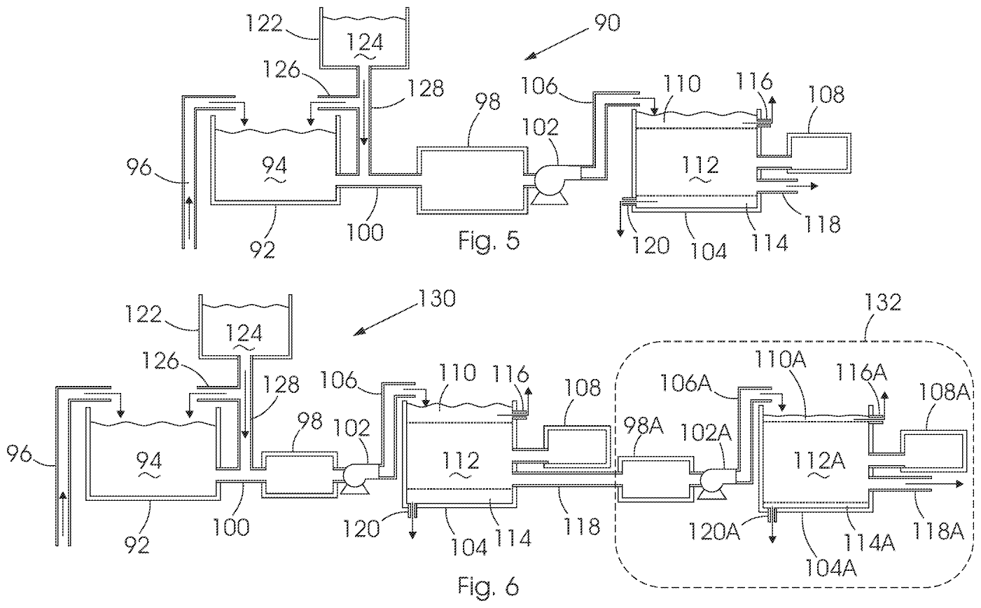

Referring to FIG. 5 of the accompanying drawings, in one such exemplary embodiment, the treatment system 90 comprises a holding tank 92, for receiving produced water 94 from an oil well (not shown) via inlet pipe 96. The produced water typically includes sediment in addition to oil. A treatment apparatus 98, typically of that type as described with reference in FIGS. 2 to 4, in fluid communication with the holding tank 92 via flow pipe 100, is arranged to treat or condition the produced water 94 received from the holding tank 92. A pump 102 is arranged to draw the produced water 94 through the treatment apparatus 98 to a separation tank 104 via outflow pipe 106. In this embodiment, the pump 102 is located after treatment apparatus 98. In alternative embodiments, it may be located before the treatment apparatus 98. The separation tank 104 includes one or more aerators 108 designed to introduce gas into the oil and water mixture being treated to form nano-bubbles therein.

In the separation tank 104, the oil and water mixture is separated into a number of fractions, being an oil fraction 110, a water fraction 112 and a sediment fraction 114. Having been separated, the oil fraction 110 can be recovered via an outlet 116, or via a spillover or rim over which the oil can flow into a collection tank or the like (not shown), the clean water fraction 112 can be tapped off via outlet pipe 118, and the sediment fraction 114 sucked off via outlet pipe 120.

The system 90 also includes a dosing tank 122 for dosing the produced water 94 with a separation fluid 124, either directly into the tank 96 via dosing pipe 126 or into the inflow pipe 100 via dosing pipe 128 just prior to flowing into the treatment apparatus 98.

Depending on the composition of the water-oil emulsion, more than one treatment zone may be required in order fully to produce clean water.

Turning to FIG. 6, an alternative exemplary embodiment of the system of the invention is shown.

In this exemplary embodiment, a second treatment/separation zone 132 is incorporated into the system. The first part of the system is similar to that depicted in FIG. 5 and the components are annotated as for the system of FIG. 5. The second treatment/separation zone 132 is characterized by having a second separation tank 104A. Separation tank 104A is fed with separated and recovered water 112 from separation tank 104 via the second treatment apparatus 98A and its associated pump 102A. Once again, oil and sediment are separated from the treated water fraction 112 to produce respective second oil 110A, water 112A and sediment 114A fractions. These are once again recoverable from respective outlets 116A, 118A and 120A. Although two treatment separation zones are depicted in this embodiment, it is to be understood that multiple zones can be employed to ensure fully treated clean water.

The clean water recovered from the systems 90 and/or 130 can be utilized in any appropriate manner, including recycling back to the oil well, if that is required, or safety disposed of without negatively impacting the environment.

In some embodiments, the fluid may comprise a liquid contaminated with oil. For example, the liquid may comprise fresh water or seawater contaminated by a crude oil spill, mixtures of oil and water resulting from rinsing of oil tankers or storage facilities, for example.

In the various embodiments, the fluid may be treated with a composition comprising lignin, and in some embodiments with at least one strain of bacteria capable of biosurfactant production, prior to being introduced into the treatment apparatus 24.

As used herein, “lignin” refers to a biopolymer that is found in the secondary cell wall of plants and some algae. Lignin is a complex cross-linked phenolic polymer with high heterogeneity. Typical sources for the lignin include, but are not limited to, softwood, hardwood, and herbaceous plants such as corn stover, bagasse, grass, and straw, for example.

In some embodiments, the lignin comprises technical lignin. As used herein, “technical lignin” refers to lignin that has been isolated from lignocellulosic biomass, for example, as a byproduct of a pulp and paper production or a lignocellulosic biorefinery. Technical lignins may have a modified structure compared to native lignin and may contain impurities depending on the extraction process. In some embodiments, the technical lignin comprises at least one of Kraft lignin, lignosulfonates, soda lignin, organosolv lignin, steam-explosion lignin, and enzymatic hydrolysis lignin. In other embodiments, the technical lignin may comprise any other form of technical lignin.

In embodiments where the lignin comprises lignosulfonates, the lignosulfonates may be in the form of a salt including, for example, sodium lignosulfonate, calcium lignosulfonate, or ammonium lignosulfonate.

In other embodiments, the technical lignin is in the form of unhydrolyzed Kraft black liquor. Black liquor is a byproduct of the Kraft process and may contain not only lignin but hemicellulose, inorganic chemicals used in the pulping process, and other impurities. In other embodiments, the technical lignin is in the form of “brown liquor” (also referred to as red liquor, thick liquor or sulfite liquor), which refers to the spent liquor of the sulfite process. In other embodiments, the technical lignin may be in the form of any other spent cooking liquor of a pulping process or any other suitable lignin-based byproduct.

In other embodiments, the lignin may be synthetic lignin or any other suitable type of lignin.

In some embodiments, the lignin is hydrolyzed. As used herein, “hydrolyze” refers to using acid or base hydrolysis at least partially to separate lignin from the polysaccharide content of the lignocellulosic biomass. For example, where the lignin is in the form of black liquor, carbon dioxide may be used to precipitate Kraft lignin from the black liquor and then the Kraft lignin may be neutralized with sodium hydroxide.

In some embodiments, the lignin is in an aqueous suspension. As used herein, an “aqueous suspension” of lignin refers to solid particles of lignin suspended, dispersed, and/or dissolved in a solvent that at least partially comprises water. In some embodiments, the solvent comprises substantially all water. In other embodiments, the solvent may comprise a combination of water and any other suitable solvent.

In some embodiments, the aqueous suspension of lignin may have a solids content of about 10% to about 75%, or about 30% to about 60%, or about 33% to about 55%. In some embodiments, the aqueous suspension of lignin may have a solids content of about 10% or above, or of about 25% or above, or of about 30% or above, or of about 33% or above. In some embodiments, the aqueous suspension of lignin may have a solids content of about 75% or below, or of about 60% or below, or of about 55% or below. In some embodiments, the aqueous suspension has a solids content of about 46%. A solids content of about 33% to about 55% allows the composition to be flowable, which facilitates flow through the treatment apparatus.

In some embodiments, the lignin comprises at least one of lignin nanoparticles and lignin microparticles. As used herein, “nanoparticle” refers to a particle in the nanometer size range, for example, between about 1 nm and about 1000 nm (1 μm), and “microparticle” refers to a particle in the micrometer size range, for example, between about 1 μm and about 1000 μm (1 mm). In some preferred embodiments, the lignin nanoparticles have a size of about 200 nm or less, or about 100 nm or less.

The lignin nanoparticles and/or microparticles can be produced by any suitable method. For example, the lignin nanoparticles and/or microparticles can be produced using at least one of: solvent shifting; pH shifting; cross-linking polymerization; mechanical treatment; ice-segregation; template based synthesis; aerosol processing; electro spinning; and carbon dioxide (CO₂) antisolvent treatment. Such methods are described in Beisl et al. “Lignin from Micro-to Nanosize: Production Methods” Int. J. Mol. Sci. 2017; 18:1244, incorporated herein by reference in its entirety.

In some preferred embodiments, lignin nanoparticles are produced using a pH shifting method, for example, as disclosed in Beisl et al. Briefly, the starting lignin material may be dissolved in a basic solution (e.g. an aqueous NaOH solution at pH 12) and the pH of the solution may be gradually decreased by addition of acid (e.g. HNO₃) to precipitate lignin nanoparticles. The solution may then be neutralized (e.g. by addition of NaOH) to re-suspend the nanoparticles. The resulting nanoparticles may have a size of about 200 nm or less, or about 100 nm or less. In other embodiments, the lignin nanoparticles may be produced by any other suitable method.

By providing the lignin in the form of lignin nanoparticles and/or microparticles, the surface area of the lignin is increased, thereby also increasing the negative force around each particle. In addition, lignin nanoparticles and/or microparticles may have improved solubility in water. Conventional lignins are typically only soluble in water at alkaline pH; however, nanoparticles and/or microparticles may be soluble in approximately neutral water (Beisl et al.), which may be preferred for some applications.

In some embodiments, where the lignin comprises an aqueous suspension of lignin nanoparticles, the zeta potential value of the suspension may be about −5 to about −80 mV. In some embodiments, the specific gravity of the aqueous suspension of lignin nanoparticles is between about 1.286 to about 1.7 SG.

The composition may further comprise at least one isolated strain of bacteria capable of biosurfactant production. As used herein, “isolated” or “isolate”, when used in reference to a strain of bacteria, refers to bacteria that have been separated from their natural environment. In some embodiments, the isolated strain or isolate is a biologically pure culture of a specific strain of bacteria. As used herein, “biologically pure” refers to a culture that is substantially free of other organisms.

As used herein, “biosurfactant” refers to compounds that are produced at the bacterial cell surface and/or secreted from the bacterial cell and function to reduce surface tension and/or interfacial tension. Non-limiting examples of biosurfactants include lipopeptides, surfactin, glycolipids, rhamnolipids, methyl rhamnolipids, and viscosin, for example. The isolated strain may be capable of producing one or more types of biosurfactant.

In some embodiments, the isolated strain may produce one or more additional active compounds. For example, the isolated strain may produce a biopolymer, solvent, acid, exopolysaccharide, and the like.

In some embodiments, the at least one isolated strain of bacteria comprises a strain of Bacillus. In other embodiments, the at least one isolated strain comprises a strain of bacteria capable of biosurfactant production and that is non-pathogenic. Non-limiting examples of suitable strains are listed in Satpute et al. “Methods for investigating biosurfactants and bioemulsifers: a review” Critical Reviews in Biotechnology, 2010, 1-18. For example, the at least one isolated strain of Bacillus may be Bacillus amyloliquefaciens, Bacillus licheniformis, Bacillus pumilus, Bacillus subtilis, or combinations thereof.

In some embodiments, the pH of the composition may be selected or adjusted to provide a suitable pH for the isolated strain(s). In some embodiments, the composition may further comprise one or more nutrients to support growth of the bacteria such as, for example, acetate, one or more vitamins, and the like.

In some embodiments, the isolated strain is in a viable form. For example, in some embodiments, the isolated strain may be in the form of a liquid suspension. In some embodiments, the isolated strain may be incubated for a suitable period of time prior to incorporation into the composition such that at least a portion of biosurfactant(s) is/are secreted into the bacterial suspension and therefore can be incorporated into the composition. For example, the bacteria can be incubated/fermented for between about one day and about six months or longer. The isolated strain may be incubated in the presence of a nutrient source and under suitable conditions (e.g. temperature, agitation, etc.) to produce the biosurfactant(s).

In other embodiments, the isolated strain may be in a lyophilized (freeze-dried) form. In some embodiments, the freeze-dried form comprises freeze-dried spores.

In some embodiments, where the isolated strain is in the form of a liquid suspension or in a freeze-dried form, the composition may comprise approximately 40 billion CFU (colony forming units) and may be combined with at least about 1 g of lignin and up to several tons of lignin.

In other embodiments, the isolated strain may be in an inviable form. For example, the isolated strain may be in the form of heat-killed cells or a cell lysate. In these embodiments, the bacteria of the isolated strain may be incubated for a suitable period of time prior to loss of viability (e.g. heat killing or lysis) such that a sufficient quantity of biosurfactant(s) is/are secreted into the bacterial suspension for incorporation into the composition. For example, the bacteria may be incubated for at least one week prior to loss of viability.

In other embodiments, a liquid suspension of bacteria may be incubated to produce the biosurfactant(s) and a supernatant containing the biosurfactant(s) may be separated from the bacterial cells and used in the composition.

Without being limited by theory, it is believed that the combination of lignin and the biosurfactant produced by the isolated strain act to mimic the natural habitat of the biosurfactant producing strains. The lignin may function as a growth substrate that contains required nutrients (carbon and fructose) to support growth of the bacteria, with the exception of additional acetate and metallic vitamins, which may be added to the composition as needed.

In some embodiments, the composition further comprises at least one of a carboxylic acid or a salt or ester thereof. In some embodiments, the carboxylic acid is a di-carboxylic acid or a salt or ester thereof. The carboxylic acid or salt/ester thereof may function as a solvent, for example, by facilitating formation of a stable emulsion of the various components of the composition. In some embodiments, the composition comprises a carboxylic acid ester. In some embodiments, the carboxylic acid ester comprises a methyl ester or a butyl ester. In some embodiments, the butyl esters are produced by biochemical metathesis. In some embodiments, the butyl ester comprises n-Butyl 4-oxopentanoate. In some embodiments, the methyl ester comprises unsaturated C₁₀ or C₁₂ methyl ester. In some embodiments, the methyl ester comprises methyl 9-decenoate or methyl 9-dodecenoate. In some embodiments, the methyl ester is produced from a plant oil feedstock.

In some embodiments, the composition further comprises carbon black. The carbon black may be electroconductive carbon black and the carbon black may function to increase the conductivity of the composition. In some embodiments, the carbon black may be conductive, superconductive, extraconductive or ultraconductive carbon black. In some embodiments, the carbon black may be in the form of carbon black beads, microparticles, and/or nanoparticles. For example, the carbon black may comprise Printex™ XE2 B Beads from Orion Engineered Carbons™. In some embodiments, the composition may comprise about 0.5% to about 10% carbon black by volume. In some embodiments, addition of carbon black may increase the negative zeta potential of the composition thereby increasing its electrical stability. In other embodiments, the composition may comprise any other highly conductive microparticle and/or nanoparticle.

In some embodiments, the composition may comprise about 1% to about 30%, or about 1% to about 20%, or about 1% to 10% of di-carboxylic acid and/or butyl esters by volume.

It has been found that relatively small amounts of the lignin-based composition are required for optimal separation results.

The treatment system disclosed herein may be useful for separation and recovery applications in the processing of fluids comprising oil and water including, for example, oil and water separation, demulsification of oil-in-water emulsions, and the like.

In some embodiments, the composition may comprise any other suitable components. For example, in some embodiments, the composition may further comprise at least one nutrient source for the live bacteria of the isolated strain.

The combination of the lignin-based separation composition with the treatment apparatus in the system, provides for enhanced separation and recovery of oil and water fractions from a mixture thereof.

Various modifications besides those already described are possible without departing from the concepts disclosed herein. Moreover, in interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

Although particular embodiments have been shown and described, it will be appreciated by those skilled in the art that various changes and modifications might be made without departing from the scope of the disclosure. The terms and expressions used in the preceding specification have been used herein as terms of description and not of limitation, and there is no intention in the use of such terms and expressions of excluding equivalents of the features shown and described or portions thereof.

1. A system for treating a fluid comprising oil and water, the system comprising:
an oil and water separation tank arranged to separate a fluid comprising oil and water into at least an oil fraction and a water fraction, the water separation tank having an inlet for receiving conditioned fluid comprising oil and water, and respective outlets for recovering, respectively, at least the separated oil and water fractions;
a treatment apparatus comprising an inlet and an outlet and defining a treatment chamber between the inlet and the outlet, the treatment apparatus inlet being in fluid communication with a source of the fluid comprising the oil and water to be conditioned, the treatment chamber including means for disturbing the flow profile of fluid received from the source thereof or agitating the fluid flowing through the chamber, thereby to condition the fluid for enhanced separation; and
a pump arranged in fluid communication with the outlet of the treatment apparatus and the separation tank to cause the fluid to be conditioned to flow through the treatment apparatus to the separation tank for the oil and water to be separated and recovered.

2. A system according to claim 1, wherein the treatment apparatus comprises a static mixer having a helical or spiral element along the length of the treatment chamber, the element being arranged to create vortices in the flowing fluid.

3. A system according to claim 1, wherein the treatment apparatus comprises a static mixer having a helical or spiral groove cut into an inner surface of the treatment apparatus defining the treatment chamber, the groove being arranged to create vortices in the flowing fluid.

4. A system according to claim 1, wherein the pump is a vacuum pump in fluid communication with an outlet of the treatment apparatus and the inlet of the separation tank.

5. A system according to claim 1, wherein the system comprises a dosing tank containing a lignin-based treatment composition, wherein the fluid is mixed with the treatment composition comprising lignin prior to being treated in the system.

6. A system according to claim 5, wherein the lignin is technical lignin.

7. A system according to claim 6, wherein the technical lignin comprises at least one of Kraft lignin, lignosulfonates, soda lignin, organosolv lignin, steam-explosion lignin, enzymatic hydrolysis lignin, or unhydrolyzed Kraft black liquor lignin.

8. A system according to claim 5, wherein the lignin is in an aqueous suspension.

9. A system according to claim 5, wherein the lignin comprises at least one of lignin nanoparticles and lignin microparticles.

10. A system according to claim 5, wherein the lignin-based treatment composition further comprises at least one isolated strain of bacteria capable of producing at least one biosurfactant, prior to being pumped through the treatment apparatus

11. A system according to claim 10, wherein the at least one isolated strain comprises at least one isolated strain of Bacillus.

12. A system according to claim 11, wherein the at least one isolated strain of Bacillus is selected from the group consisting of Bacillus amyloliquefaciens, Bacillus licheniformis, Bacillus pumilus, Bacillus subtilis, and combinations thereof.

13. A system according to claim 5, wherein the lignin-based treatment composition further comprises at least one of a carboxylic acid or a salt or ester thereof, such as a methyl ester or a butyl ester, or a di-carboxylic acid or a salt or ester thereof.

14. A system according to claim 5, wherein the lignin-based treatment composition further comprises carbon black.
